(19) United States
(12) Patent Application Publication
(10) Pub. No.: US 2025/0238095 A1
(43) Pub. Date: Jul. 24, 2025

(54) TOUCH INTERFACE DEVICE PROTECTING AND WIRELESSLY COMMUNICATING WITH A SHOWCASE

(71) Applicant: Stefan Petru COTET, Bucuresti (RO)

(72) Inventor: Stefan Petru COTET, Bucuresti (RO)

(21) Appl. No.: 18/833,396

(22) PCT Filed: Jun. 3, 2022
(86) PCT No.: PCT/RO2022/050006

§ 371 Date: Jul. 26, 2024

(30) Foreign Application Priority Data
Jan. 28, 2022 (RO) U 2022 0004

(51) Int. Cl. G06F 3/041; G06F 3/01; G06F 3/042

(52) U.S. Cl. CPC G06F 3/04162; G06F 3/017; G06F 3/0421

(57) ABSTRACT

The invention relates to a gestural and tactile interface comprising an external module (damageich allows a user to interact wirelessly with a gesture taking device (102), which operates by detecting interruptions of infrared beams emitted by LEDs (D) incorporated on two of the adjacent sides of the device, and on the respective opposite sides are installed infrared photodiode receivers (C); the gesture taking device (102) continuously transmits information regarding the user's finger position coordinates to a protected module (200) containing a multi-core processing unit (201) which shows the user interaction's result by displaying the information on a screen (202), separated by a transparent protective medium against the gesture-taking device (102) with which it communicates by transmitting the signal via radio waves; all of these functional elements assemble a mobile device capable of operating autonomously, inductively powered, in safe conditions that limit any potential damages caused by misuse or vandalism.

### BACKGROUND OF THE INVENTION

The invention relates to a gestural interface that allows a user to interact with a device capable of interpreting gestures and turning them into commands to a receiver attached to a processing unit, and the result of these commands will be presented to the user at least by displaying information on a screen, located behind a transparent protective medium, such as a showcase of any type of glass, including safety glass and laminated glass, which keeps a certain distance between the wireless communication device and the processing unit by transmitting the signal via radio waves, the power supply of the external module being provided by induction by the protected module, so that all these functional elements make up a mobile device capable of operating autonomously, protected from abuse or vandalism.

Human Interface Devices (H.I.D.) are known in the art as a sort of wired computer-interface device used by the human operator of a computer system to send or receive information, on which at least one analogue/digital conversion is performed; some technical solutions use the ability to turn gestures made by people into interaction with an advanced electronic device, such as tablets and smartphones with integrated touch screens, dedicated VR (virtual reality) or AR (augmented reality) headsets.

A disadvantage of the known solutions is that they are mainly dependent on fixed-wired electrical connections due to their constructive complexity and need for high transmission speed. Another disadvantage is that devices that can be interconnected wirelessly require stand-alone power supplies that cause technical problems with battery replacement. Another disadvantage relates to the need to protect those devices, which are usually very expensive, against misuse or even vandalism, requiring—as a consequence—permanent monitoring of the devices by qualified personnel.

### OBJECT AND SUMMARY OF THE INVENTION

The object of the invention is to facilitate the interaction between a user and a secure electronic system located behind a shop window and improve mobility, involving the lowest possible costs for the power supply but at the same time offering the highest possible level of protection for high-value components, against misuse or even vandalism, without the need for permanent monitoring of the devices by qualified personnel.

The technical problem solved by the invention relates to the realization of an external module that allows the use of the glass surface of a showcase as a tactile interface, capable of taking over the gestures of a user and transforming them into commands that he transfers without having to pierce the window, using a radio transmitter/receiver system to a protected module containing a processing unit and a screen on which the result of commands corresponding to the user's gestures will be displayed as a result of that interaction.

Wireless gestural interface for touch showcases according to the invention removes the disadvantages of known solutions in that, it consists of at least one external module (100) which allows a user to interact with a gesture-taking device (102), which works by detecting interruptions infrared (IR) fascicles emitted by the built-in LEDs (D) on two sides of the device, to photodiodes (C) with receivers positioned on opposite sides of the IR LEDs (D); the gesture taking device (102) transmits by wired connection the information concerning the coordinates of the user's finger position to a single-board processing unit (101), which in turn shares that information via a wireless connection to a protected module (200), comprising a central multi-core processing unit (201), which shows the result of the user interaction by displaying the information on a screen (202) located at a certain distance from the gesturing device (102) which communicates by transmitting the signal via radio waves; the outer module (100) is powered by at least one battery (103) which is charged by means of an inductive charging receiver (104) which receives the necessary current from an inductor (204) included in the protected module (200).

Wireless gestural interface for touch showcases, according to the invention, has the following advantages:
the invention has a very competitive cost compared to the prior art solutions;
the amount of damage that can be caused to the module exposed to the outside by improper use or even vandalism is not significant concerning the benefits to the user;
the invention can be used both in the private and public system, in administrative-territorial centres and in institutions in fields as diverse as possible;
the devices can be used for advertising, promotional campaigns, institutional/corporate communication, data collection, subscriptions, etc.;
the device can operate fully autonomously, without requiring periodic maintenance, but only occasional;
the invention proposes the development of a new concept of digital street marketing, by the optimal approach of the demand to the supply—by direct interaction, with the immediate result;
reduction of advertising costs related to the purchase of paper, printing, and distribution, all being done via the Internet, in digital format;
the abandonment of printing on paper for advertising or information purposes provides ecological benefits;
the possibility to upload on the same medium in various forms: digital magazines, movies, sounds, user-computer interaction;
remote loading of promotional materials (or software components) from a control centre without the need to travel to the field;
remotely change the displayed content (or software components);
the simple and intuitive way of accessing and interacting with the information presented—anyone can click or tap or scroll, notable for the astonishing speed with which these terms have entered the usual vocabulary;
the possibility of being used both outsides, attached to the showcase of a shop and also inside, as a stand-alone stand;
the devices are easy to spot and attract the attention of potential users.

An embodiment considered advantageous for a wireless gestural interface for touch showcases according to the invention is illustrated in FIG. 1 . . . 5 as follows:

### BRIEF DESCRIPTION OF DRAWINGS

FIG. 1—a simplified chart representing the taking of the gestures according to the invention—isometric and transversal representation, rendered in parallel;

FIG. 2—operating block diagram in a preferred embodiment of the invention;

FIG. 3—flow chart of interactions between the components in the invention embodiment;

FIG. 4—organization chart of the running processes in a preferred embodiment of invention;

FIG. 5—diagram of the operation of device 102 for taking gestures by touch.

### DESCRIPTION OF THE INVENTION

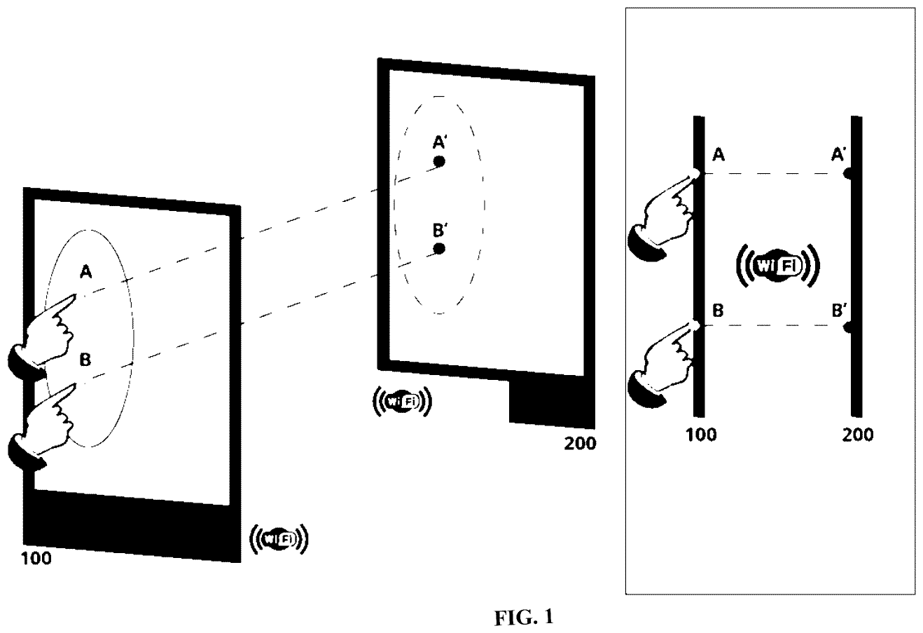

In FIG. 1, from the production's perspective, we start from a rectangular frame that will respect the constructive form and the proportion of the device 102 for taking gestures to which are added the components: single-board processing unit 101, battery 103 and inductive charging receiver 104.

As a frame material—in this example, in the form of a frame—which will support the external module 100, we consider the factors that influence the operation in optimal conditions: the metal cannot be used in the area of operation of the induction load because the inductive load comes out of the optimal functional parameters in the presence of the metal.

The mounting of the inductive charging receiver 104 and the inductor 204 must be made so that these components are perfectly aligned, without the interposition of metal elements or other materials that interfere with the electromagnetic field generated by the inductor 204 and received by the inductive charging receiver 104 during charging. From a productive point of view, we will be able to use wood, plastic (including thermoforming), or epoxy resins (with characteristics of high toughness for hardening to provide protection), as a finish we can use decorative stickers.

To be functional, a system contains at least two distinct modules described below: on a hand, an external module 100 represented in its turn by a set of hardware and software devices according to the invention, and on the other hand, a protected module 200 which can be represented by an ordinary PC type system, as a processing unit 201—with additional peripherals, comprising a screen 202 and a modem/router 203.

The term “module” as referred to, includes software, hardware and combinations thereof in the embodiment of the present invention. In the presented embodiment, the software may be machine code, firmware, embedded code or application software and the hardware may be a circuit, a processor, a computer, an integrated circuit, an infrared sensor, a inductive charging circuit (also known as wireless charging), microcontrollers, relays, function boards, active and passive devices or a combination thereof. External module 100 contains, in addition to the hardware components described above, a number of software components that are commercially used—commercially licensed—or free of charge (GNU General Public License).

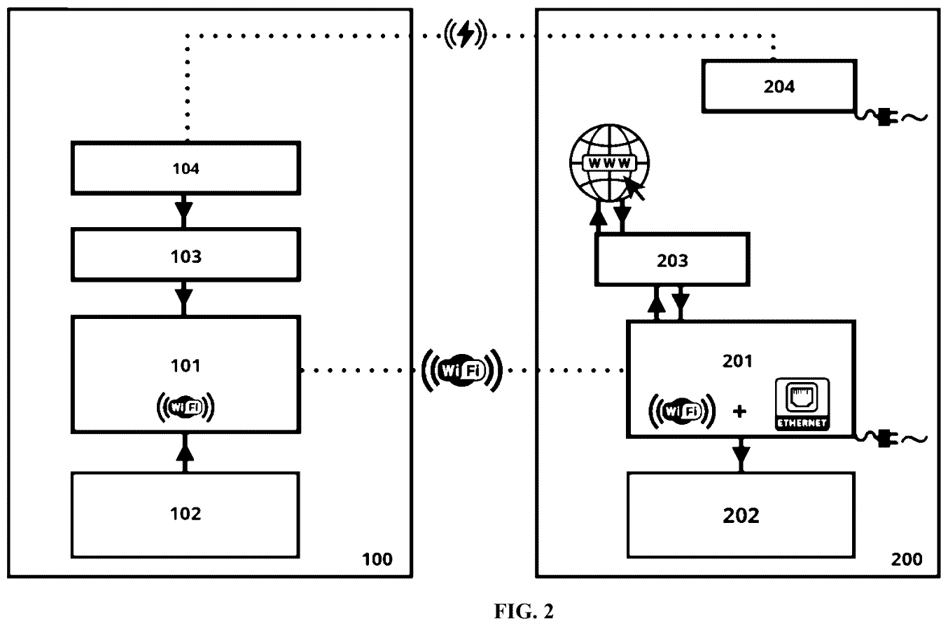

The external module 100 having the operating principle illustrated in FIG. 2, contains a single-board processing unit 101, a device 102 for taking gestures (HID type) in the infrared spectrum (IR) having a USB connection; a battery 103 (or group of batteries) that supplies the components of the outer module 100; an inductive power supply 104 according to the Qi standard. The mentioned components are also available on their own in the prior art, but the assembling of these hardware and software elements according to the invention result in a device capable of transmitting wireless gestures wirelessly, fully mobile and autonomous, accessible in inconceivable situations for the prior art, unexploited and/or unused, such as mounting the external module 100 on a showcase (detailed below, in the description of this embodiment of the invention).

A small single-board (single-core CPU) processing unit 101 is used, about the size of a business card, that utilizes the Linux operating system as a software platform, containing one or more USB ports, of which the at least one USB port will be assigned to a gesture taking device 102.

If we want to multiply the number of gesture-taking devices 102, we will have to choose a single-board processing unit 101 so that it can support all gesture taking devices 102, either through its own separate 1 to 1 connection or through one or more USB HUBs (USB input-output multipliers). The single-board processing unit 101 must have a connection to “wireless” networks in the Wi-Fi standard (802-11x) either integrated by the factory or through an external module (e.g.: “dongle”) attached. The main function of the single-board processing unit 101 is to record the gestures captured by the gesture taking device 102 and encapsulate/encrypt them in a wireless signal. The response speed of the gesture taking device 102 must be slower than the response speed of the unit 101 and together they should have a low response speed so that the user does not perceive delays.

In FIG. 1 we see that the user's gesture from point A to point B is indicated by module 200 protected on a screen 202. If the information processing speed did not exceed the minimum response display latency, it would result in an unwanted delay, a noticeable delay between the user interaction represented by the gesture taken by the external module 100 and the response displayed on the screen 202 by the protected module 200. The speed offered by the Wi-Fi connection, the signal carrier from one module to another, also contributes to this aspect. With the standard 2.0 native (native) USB 2.0 connection, the average latency of a gesture 102 device is <16 ms. This latency must be taken into account because the response of the 200 protected module must be displayed on screen 202 “in real-time” without any noticeable delays by the user. As software, the single-board processor 101 integrates a Linux operating system with software components strictly necessary for the operation of the gesture taking device 102 and the operation of the integrated Wi-Fi module so that power consumption is maximised.

The processing unit 101 used in the project has small dimensions, favouring the mobility concept of the invention because the single-processor units are available more and more miniaturised with the technological development.

The single-board processing unit 101 and the processing unit 201 must be connected to the same Wi-Fi network.

We further detail the characteristics of a gesture-taking device 102, functional via USB type connection. The simple construction, the native integration in multiple software platforms, the low weight, and the high mobility make the gesture recording device an element of particular importance in the disclosed invention. Under the name “Plug and Play” connection, the USB interface of the device helps to connect it to the single-board processing unit 101 easily.

The abbreviation HID comes from “human interface device”, respectively, the interaction interface between a device and the user. HID devices are divided into input devices and output devices.

HID devices protocol includes two entities: “host” and “device”. These entities are connected through certain interfaces or ports, which can be of several types: “USB”, “parallel” or “serial”, “bluetooth”, referring to the type of protocol adopted for the connection between “host” and “device”. The term “HID” refers—in state of the art—most frequently to the specification “USB-HID”, which is the most common type of device in this category. Examples of input devices: USB (wired) or wireless keyboard, USB (wired) or wireless mouse, video (web) camera, USB (wired) simulation devices—joystick/trackball, steering wheel, handle, pedals, VR (virtual reality) devices via USB (wired) or wireless (bluetooth), USB (wired) devices for taking gestures in the infrared (IR) spectrum.

Examples of output interface devices: computer monitor, Braille high refresh rate display, speakers for sound playback, headphones for sound playback, devices with touch technology (Haptic technology).

Being extremely close to the technology used in the disclosed invention, we will explain the notion of touch technology, also known as kinesthetic communication or 3D touch, referring to any solution that can create a touch experience by applying forces, vibrations or user movements.

These technologies can be applied either to create virtual objects in a computer simulation or control such virtual objects and improve the remote control of machines and devices (telerobotics).

The main features of a USB Infrared (IR) wired gesture taking device 102 via an USB connection are as follows:
allows multi-touch touch (instantly), transmitted immediately by the device: with specific software platforms, the device can accept up to 40 touch points simultaneously;
reliable construction solution with low manufacturing costs;
Plug & play capability—includes recognition/identification software in most operating systems, which facilitates automatic/native recognition by multiple software systems, diversifying configuration/integration possibilities;
allows a high resolution (number of points recorded on the X-Axis and Y-Axis;
increased accuracy when taking gestures+/−1.5 mm;
fast response time: between 7 and 16 ms; usually, in less than 8 milliseconds, IR devices have located tactile events by detecting light interruptions, being accurate and fast when responding through interactions;
dimensions of the active surface up to 1000 meters diagonal: the factory setting of certain diagonal standards and scaling factors of the diagonal in which the screens are located so that they correspond (as closely as possible) precisely to the point of contact with the point indicated on the screen;
economical option because—compared to other types of touch screens—the cost of infrared (IR) gesture recording devices is relatively inexpensive, even for large touch screen sizes;
sharper display—without other substances when superimposed on a screen, IR devices offer the best light transmission so that they can render more vivid images without loss of colour and brightness;
writing experience is improved—the overlap is often a piece of glass; it is easy to write on this type of medium;
no scratches—the LCD screen is protected by glass, eliminating the risk of scratches;
more effective in customising the screen size—by adjusting the number of LEDs and photodiodes built into the overlay on the screen, you can mount any custom screen under an IR touch interface;
easy maintenance—there is no adhesive between the display and the IR device, so the two parts can be freely disassembled, removing a few screws when performing regular maintenance work, such as fi cleaning surfaces, and dusting;
clear images—compared to many camera or projector-based systems, IR touchscreen equipment often adopts infrared LEDs for rear lighting, so regardless of the lighting environment in which they operate, they can provide clear images to the public;
supports 4K resolution screens and can work well with large pixel screens;
no loss in the screen area—because the D LEDs and C photodiodes used as receiving sensors are designed to be placed in a frame that sits around the screen; the screen may have an unrestricted view;
writing can be performed with any object on an IR device: a bare finger, a finger in a glove, wet hands or a stylus, as long as it is not transparent;
unlike the smart projector board, which may require regular calibration to correct images, IR devices do not require periodic calibration of LEDs D and photodiodes C to ensure regular operation;
no pressure is needed to write or make a gesture—resistive touch device technology senses pressure typing, which can damage the screen after prolonged use, while IR touch technology detects interruption of light in the invisible spectrum of infrared, so that it can be written freely, without the need for strong pressure on the “screen surface”.

We further describe the characteristics of a battery or group of batteries 103 that powers the external module 100 (single-plate processing unit 101+gesture taking device 102). The capacity of a battery will be calculated according to the formula:

Power consumed by: (101)+(102)+(103)<(104).

Battery capacity is not a constant value, accurately expressed mathematically. Even an unused battery loses its parameters over time, and its capacity decreases. The factors that influence its lifespan, meaning its capacity, are presented in the data sheets. The main factors are the operating temperature in areas other than those specified by the manufacturer, the number of charging/discharging cycles, the discharge below the allowable voltage, the overcharging of the battery, and the discharge at excessive currents. As an example of calculating the power of a battery, a single-board processing unit 101 consumes 5 V and 350 mAh, and a gesture taking device 102 consumes 5 V and 250 mAh, resulting in power consumption:

$$( W ) 5 V \times ( 350 mAh + 250 mAh ) = 5 V \times 600 mAh = 5 V \times 0.6 Ah = 3 W .$$

Battery 103 must be more powerful than 3 W/h. At a voltage of 5 V it means that a battery with a capacity of 600 milliamps would keep the system running for 1 hour. For 24 hours, the battery should have a capacity of 24 h×0.6 Ah=14.4 Amps. This would lead to a large size in terms of the dimensions of the external module 100. To optimize the space, we choose to install one small battery and a wireless charging system according to the Qi standard, containing the inductive charging receiver 104 and the inductor 204, which determines the mobility and the completely autonomous state of the external module 100, facilitated by the lack of fixed wires or wiring in the system, according to the invention, with the aid of state-of-the-art wireless communication technologies, both for data communication (transmission/reception) and for the inductive transmission of low voltage currents.

The external module 100 also contains a compatible inductive charging receiver 104, according to the Qi standard, with an inductor 204, which ensures continuous charging for a long period of time, thus requiring frequent maintenance interventions, so that the external module 100 becomes autonomous, providing the basic functionality of transmitting user gestures, without the need for electrical and data wiring, to the protected module 200.

We further describe the characteristics of an inductive charging receiver 104 part of the wireless charging system, according to the Qi standard.

Wireless charging represents the transfer of power from a socket (220 Volt AC system) to a low-power device (e.g. 5 Volts) without the need for a connecting cable between devices. This involves a power transmission device (inductor) and a receiver, sometimes in the form of a case attached to a mobile device or embedded in the phone. Wireless charging is based on inductive charging, where power is created by passing an electric current through two coils to create an electromagnetic field. When the magnetic receiving board on the mobile device comes in contact with the transmitter—or at least within the specified range—the magnetic field generates an electric current inside the device. This current is then converted to direct current (DC), which in turn charges the battery 103.

The main wireless charging standard in the prior art is Qi (pronounced “chee”). Qi is a standard that was developed by the Wireless Power Consortium (WPC) for inductive charging up to 40 mm. The key parameter in choosing these devices from a technical point of view is the charging power, which must be higher than the power consumed by the external module 100 to ensure the time required for a battery 103 to fully charge during this process. If battery 103 is not fully charged, the system will run out of power, so it will no longer be autonomously. The system in our example needs 3 W to operate for one hour, so we need to choose an inductive system with a minimum charging power of 5 W (the minimum standard in the prior art).

### Results:

$$5 W = 5 V \times 1 A ( 1000 mA ) ; 1 A \times 24 hours = 24 A .$$

Our consumption is 14.4 Amps, so the device 100 is autonomous because we can provide a higher power when charging. However, the consumption can vary depending on the environmental conditions, the outdoor module 100 being subject to the factors of temperature, humidity, and wind. Using a minimum of 5 W (standard) charging power, we reach 24 A/24 hours, representing a percentage of 66.66% over the capacity of 14.4 A/24 hours expressed in theory.

Using a 10 W system, results in:

$$10 W = 5 V \times 2 A ( 2000 mA ) ; 2 A \times 24 hours = 48 Amps$$

=>333.33% above the minimum required capacity calculated by 14.4 A for 24 hours.

The device in the advantageous-considered exemplified embodiment, according to the invention, can operate without maintenance, completely autonomous, either in permanent mode (non-stop) or according to a work program pre-established through software modules—this being finally decided by the owner, which can choose to have the devices turned off outside of the store's business hours—for example, inside the “mall” buildings during the night, when customer access is restricted.

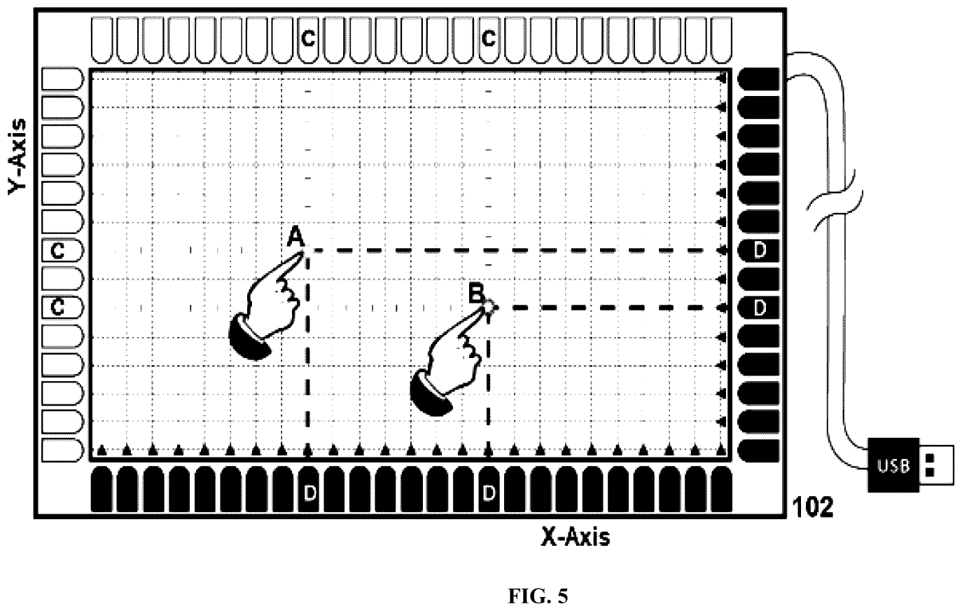

As shown in FIG. 1, the description of the gesture processing mechanism shows the external module 100 with its components 101, 102, 103 and 104 and the protected module 200 with its components 201, 202, 203, 204 (but which may vary functionally and constructively—it is essential to have at least one screen 202 on which to see the result of the interaction through gestures taken over by the external module 100). When a user interacts via gesture taking device 102 with the things displayed on screen 202, the user touches an area marked with A in FIG. 1. As shown in FIG. 5, the LEDs D in the gesture taking device 102 have the signal interrupted by the user's gesture and thus the signal no longer reaches the photodiodes C (the user's gesture is an obstacle introduced in the way of infrared waves emitted from D to C). This point A is transmitted as coordinates on the X-Axis and Y-Axis to the single-plate processing unit 101, which transmits them to the processing unit 201, which in turn transmits them to the screen 202 as modified information according to the interaction indicated by the information communicated to the singleboard processing unit 101. The user moves his hand on the trajectory A . . . B, and all this time the electronic elements D emit infrared waves, the elements C receive infrared waves, so that the gestures taking device 102 (as per FIG. 5), continuously transmit information related to the coordinates on the X-Axis and Y-Axis.

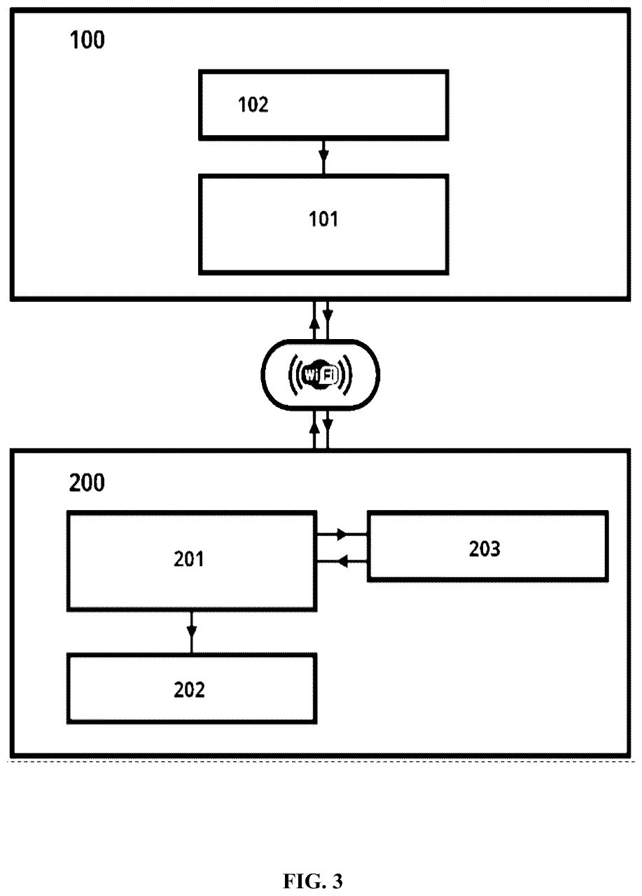

In FIG. 3 we describe the operation of the electronic system, without the voltage supply part. Thus, the gesture-taking device 102 transmits information to the single-board processing unit 101, the communication being executed only in one direction from the gesture-taking device 102 to the single-board processing unit 101, by wire, through USB connection. The single-board processing unit 101 then packs the wirelessly received signal from the gesture taking device 102 into a signal which, in turn, it will wirelessly transmit via Wi-Fi to the processing unit 201.

The Wi-Fi connection is performed in both directions, from the single-board processing unit 101 to the processing unit 201 and reversibly, from the processing unit 201 to the single-board processing unit 101. In the case of screen 202, as the output device, the signal will be executed only from the processing unit 201 to the screen 202.

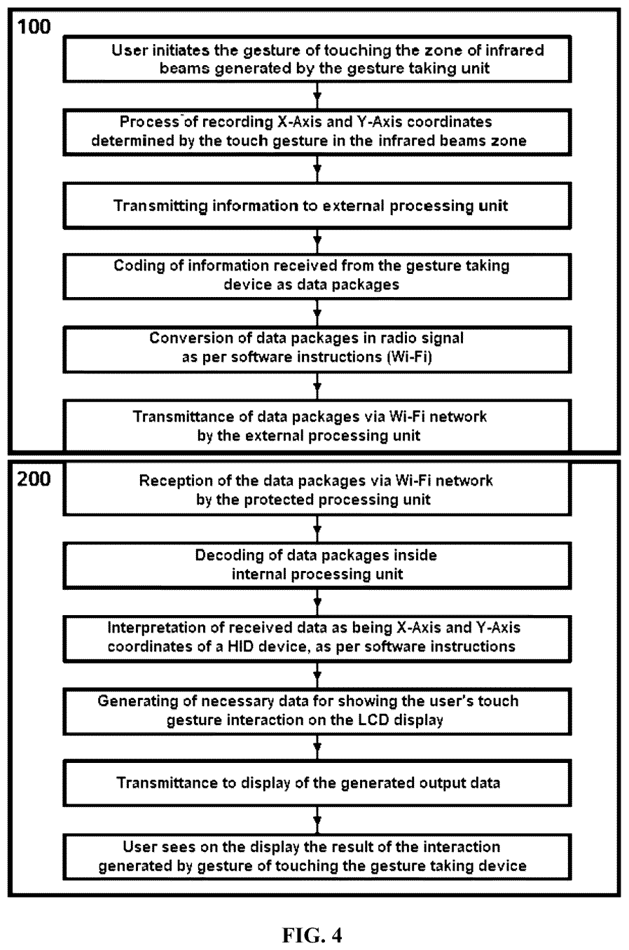

FIG. 4 illustrates the flow chart of the processes taking place in the embodiment of the invention, showing all the processes that run during an example of interaction between the user and the central processing unit (PC) 201 described in FIG. 1.

A protected module 200 contains: multi-core processing unit (mini PC) 201 equipped with an information storage unit, 220V AC power supply unit, graphic/visual interface peripheral equipment having the role of showing information/images managed by the unit central processing unit, such as a 202 screen, a 4G wireless router 203 having the role in connecting to the appropriate data network, as well as a USB Wi-Fi adapter having the role of taking the Wi-Fi signal generated by the single-board processing unit 101 in the external module 100. The protected module 200 also contains a wireless charging system represented by an inductor 204 (induction system) according to the Qi standard for wireless charging.

Protected module 200 consists of both the hardware components described above and custom software components utilised for commercial use—commercially licensed—or free of charge.

Starting from the definition of “gesture”: “Movement of the hand, head etc. which expresses an idea, a feeling, an intention, sometimes replacing words or giving more expressiveness to speech”, we can extrapolate the need for an electronic system with a gesture processing mechanism suitable for remote interactions between the user and current devices, so that the processing unit 201 is positioned in a different place than the gesture taking unit 102. Thus, the whole system becomes much more modular and more suitable for various installation options, exponentially increasing the potential for exploiting the interactivity between user and device.

Virtual reality (VR) and augmented reality (AR) are technologies that change the way computers are used, creating new interactive experiences. Virtual reality uses a headset to place us in a computer-generated world that we can explore. Augmented reality, on the other hand, instead of transporting us into a virtual world, generates digital images that are superimposed on the natural world around us, observable through the use of a clear visor or smartphone. With virtual reality, we could explore an underwater environment. With augmented reality, we could see the fish swimming around us.

Extrapolating, the described invention takes to another level the interactivity between man (through the gestures performed) and the computer, bringing the entrance part (input-taking gestures) in places where before it did not exist, at anyone's fingertips: on the street, in the store, in parking, in the mall, keeping—at the same time—the processing unit 201 and the screen 202 in a safeguarded, protected, secured environment.

FIG. 5 depicts the operation of a touch gesture taking device 102, which mainly contains two groups of components: LEDs D transmitting light rays in the infrared spectrum (invisible to the naked eye) and photodiodes C acting as receivers. The device also contains a micro-controller which has the function of transmitting the coded signal via the USB interface to the processing unit (PC) 201. Infrared (IR) gesture taking device 102 works by detecting interruptions of infrared beams emitted by the infrared LEDs D embedded in two of the adjacent sides of the device, which generate invisible horizontal and vertical IR beams, as shown in FIG. 5, said beams forming a grid (in the IR spectrum, invisible) which covers the tactile surface. On the opposite sides of the infrared LEDs D, photodiodes C with receiver functions are installed. As long as an opaque object (the finger of a hand, a pen, or a pointing object) touches the surface bounded by LEDs and photodiodes, it will interrupt the light beams. Photodiodes C from both directions (vertical and horizontal) will detect this interruption generated by the opaque object and after locating its coordinates on the horizontal axis and the vertical axis, will send the signal to the micro controller to respond with relevant actions.

The gesture picker usually connects to a PC via USB port. The invention transforms the wired USB connection into a wireless connection using hardware and software components.

The primary purpose of the wireless connection is to facilitate the installation of the system in innovative places outside the shops and supermarkets, bringing the advantage of using the touch function in environments where it has not been implemented so far. If installed indoors, the user has access to the system only when the store or location where it is installed is open. According to the invention, the system carries out the interaction part by gestures, and the user has non-stop access to the interactive functions of the system.

To understand the invention, we propose the following case study:

We stand in front of a store showcase. A printed poster is applied behind the glass. While beautifully coloured, it cannot express more than its written message. The customer moves away, there is no interactivity, printing costs are very high, and the competitiveness ratio of the printed poster compared to the object of the invention is considerably lower.

Now let us imagine a shop window outside, which is an interactive frame containing the touch gesture taking device 102, and behind the window is the screen 202 and the central processing unit 201, sheltered from the weather and the risk of vandalised. A message is displayed on screen 202 and after a few seconds, another message and then another. From a simple print with a single “passive” message, we now have the opportunity to see countless messages, offers from different categories, and multiple promotions. But we don't just stop for watching multiple sequences and messages. With the interactive frame that integrates the gesture taking device 102 we can interact with the content on the screen 202. More details about a promotion or a product can be presented, or immediate benefits of interacting with the system can be obtained using related mechanisms (generation QR code, personalised SMS message) through which the customer takes possession of the promoted merchandise with a discount that solely applies if he “opens”, by the touch gesture, the promotion displayed at some point on the screen 202. It is no longer necessary to enter the store, the entire purchasing process can be solved in a short time through an interaction with the system installed on the store showcase. Users are accustomed to gestures performed on miniaturised mobile devices, and the invention allows the application of the experience gained by using mobile devices without the need for special training.

The advantages in the advertising industry are perfectly measurable, given that any interaction can be recorded by the system and reported in specific applications to communicate the performance obtained (such as Google analytics).

Examples of fields in which the invention can be successfully integrated: education (children's interactivity with digital media); fashion stores and more; retail (supermarkets, horeca), museums and other tourist attractions; Government and Local Councils (communication of updated information “per second”), transport (real-time information on traffic and information); medical and pharmaceutical assistance; passenger transport (info-kiosks, vending machines).

The described example is only a particular form of application of the invention, which is not limited to this particularisation, the broader applicability of the disclosed technical solutions being noticeable to a person skilled in the art.

What is claimed is:

1. Wireless gestural interface for touch showcases characterized in that, it consists of at least one external module (100) which allows a user to interact with a gesture taking device (102), which operates by detecting interruptions of infrared (IR) beams emitted by the infrared LEDs (D) embedded on two of the sides of the gesture taking device (102) to photodiodes (C) as a function of infrared receivers positioned on opposite sides of the infrared LEDs (D); the gesture taking device (102) transmits information about the coordinates of the user's finger position to a single-board processing unit (101), which in turn transmits that information via a wireless connection to a protected module (200) containing a multi-core processing unit (201) which shows the result of user interaction by displaying the information on a screen (202) located at a distance from the gesture-taking device (102) with which it communicates by transmitting the signal via radio waves.

2. Wireless gestural interface for touch showcases, according to claim 1, characterized in that, the outer module (100) is powered by at least one battery (103) which is charged utilizing an inductive charging receiver (104) which receives the necessary current from an inductor (204) included in the protected module (200).

3. Wireless gestural interface for touch showcases, according to claim 2, characterized in that, the protected module (200) is located behind a transparent, secure environment that limits any damage caused by misuse or vandalism.
